(19) United States
(12) Patent Application Publication
(10) Pub. No.: US 2013/0069025 A1
(43) Pub. Date: Mar. 21, 2013

(54) POST AND STAKE PULLER

(71) Applicant: JESSE SCHOOLEY, Clearwater, FL (US)

(72) Inventor: JESSE SCHOOLEY, Clearwater, FL (US)

(21) Appl. No.: 13/238,120

(22) Filed: Sep. 21, 2011

(51) Int. Cl. B66F 1/00

(52) U.S. Cl. 254/30

(57) ABSTRACT

A post puller that includes a jack assembly with an assembly attached to the jack housing that includes wedges with sharpened edges that bite into the post or stake as the jack assembly is raised.

### FIELD OF THE INVENTION

The invention relates to an apparatus used to pull wooden and metal posts and stakes out of the ground.

### BACKGROUND OF THE INVENTION

Pulling posts out of the ground such as 4×4, 6×6, 8×8 inch posts and round fence metal posts and the like as well as stakes of any shape and sizes such as tent stakes, can be very difficult and strenuous. The present invention provides for an apparatus that facilitates the removal of such posts and stakes while minimizing the strenuous efforts typically required for the removal of such posts and stakes.

### SUMMARY OF THE INVENTION

The present invention is a device to remove fence posts, stakes and the like from the ground. The device allows for the removal of a wood post, in most cases a 4×4 inch post, and metal (aluminum or steel) posts like those used on chain link fences. It also allows for the removal of metal and wooden stakes such as those used as tent anchors and larger posts such as those used as piers under structures such as 6×6 and 8×8 posts under a cottage near a body of water.

Generally, the invention is a post or stake puller comprising a jack assembly with a detachable foot assembly. Attached to the housing of the jack assembly is a structural support base member transversely fixed to an intermediate portion of the outer housing of the jack assembly. The structural support base member has a vertically oriented face with a predetermined width and height, a pair of spaced-apart channel members having at least two contiguous sides generally perpendicular to each other. One edge of each of the pair of spaced-apart channel members is fixed to the vertically oriented face and spaced-apart so as to act as a guide for placing the post puller adjacent a post to be pulled where each channel member is aligned juxtaposed opposite faces of the post to be pulled.

The invention includes a pair of rods, each rod having one end fixed to the vertically oriented face and oriented parallel to a corresponding spaced-apart channel member leaving a gap between the corresponding spaced-apart channel member and the rod. Each rod has a predetermined length that is longer than the corresponding spaced-apart channel member. A pair of wedge members have a predetermined length wherein at least one edge of the wedge members along the length of the wedge members has a tapered edge for biting into opposite faces of the post to be pulled.

The invention further includes a tubular-shaped member fixed to each of the pair of wedge members. The tubular-shaped member has an internal dimension sufficient to concentrically slide over a corresponding rod wherein a portion of the combined wedge member and the tubular-shaped member slides between the corresponding rod and the corresponding spaced-apart channel member and each of the combined wedge member and tubular-shaped member is rotatable about the corresponding rod so that the tapered edge is rotated against the post to be pulled for biting as the outer housing of the jack assembly is raised. Each of the combined wedge member and tubular-shaped member has a predetermined length that is shorter than said corresponding rod.

The invention further comprises means for preventing said combined wedge member and tubular-shaped member from sliding out of its engagement with said corresponding rod. This can be provided in a number of ways such as a removable cap but a preferred method is by providing a washer that slides over the rod and a face of the washer butts against an outer edge of the combined wedge member and tubular-shaped member, and a pin insertable through an aperture adjacent an outer edge of the corresponding rod.

The detachable foot assembly comprises a generally planar base member and a receptacle for engaging a lower end of an inside shaft of the jack assembly. When the invention needs to straddle a post such those where concrete has been previously poured around a base of a post or stake, an alternative foot assembly may comprise two spaced-apart legs, where each of the legs has a generally planar base member at corresponding lower ends of the legs; and an upper transverse member has a receptacle on its upper surface for engaging the lower end of an inside shaft of the jack assembly. The foot assembly may be designed to allow the jack assembly to be operable at a desired angle such as 30° to 45° to allow for removing posts or stakes that have been installed at an angular orientation.

### BRIEF DESCRIPTION OF THE DRAWINGS

In the accompanying drawings:

FIG. 1 is a perspective view of one embodiment of the invention;

FIG. 2 is an exploded view of the components depicted in FIG. 1;

FIG. 3 is a perspective view of an alternative embodiment of a detachable foot assembly;

FIG. 4 is a top view of the embodiment of FIG. 1;

FIG. 5 is a front view of the embodiment of FIG. 1; and

FIG. 6 is a depiction of a conceptual example of an embodiment of the invention related to a wedge design to remove round posts.

### DETAILED DESCRIPTION OF THE INVENTION

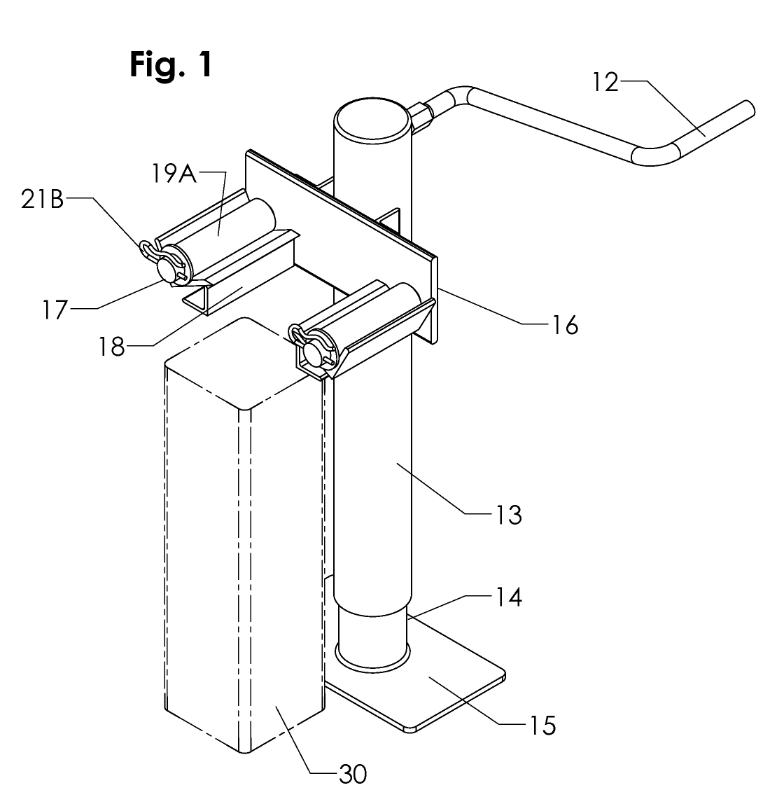

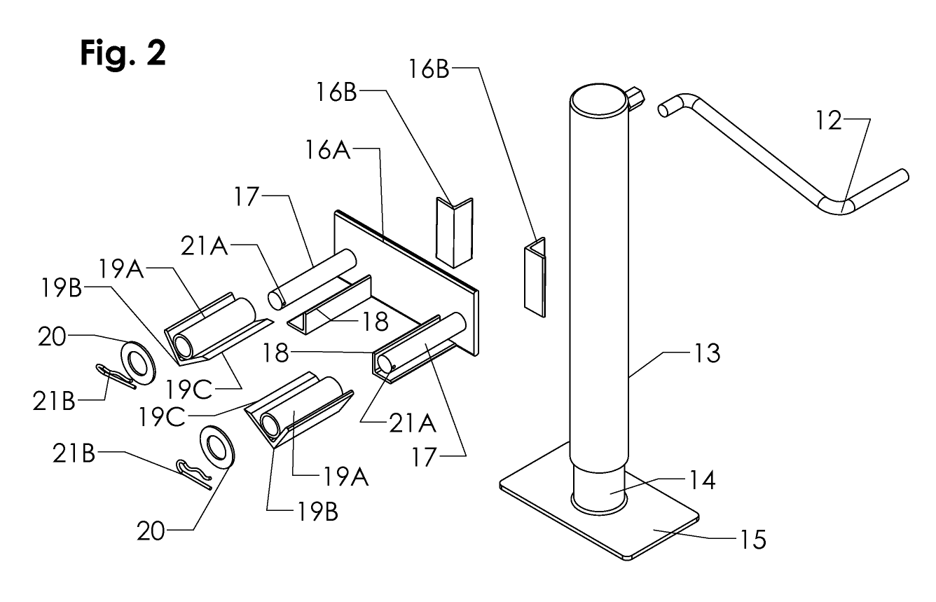

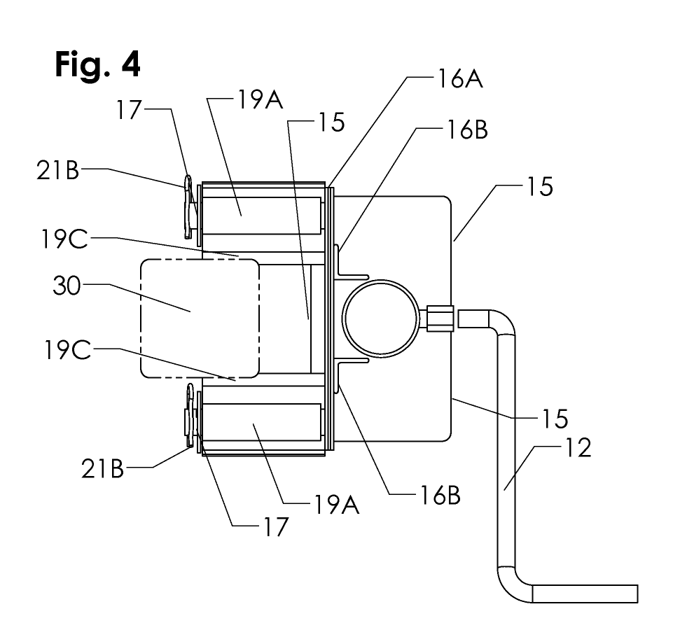

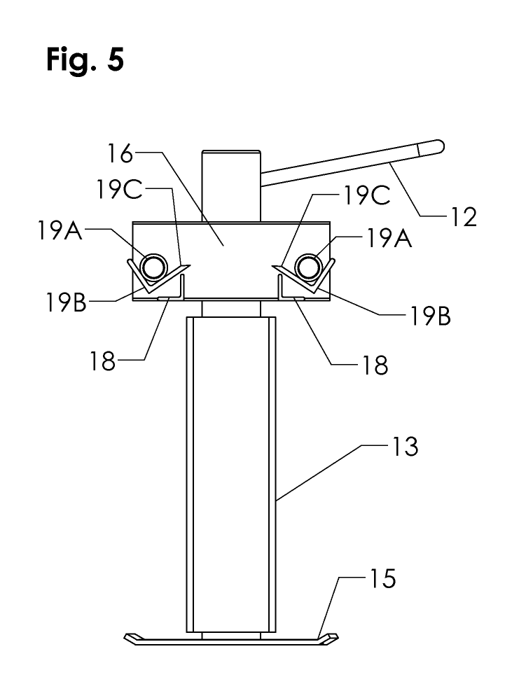

Referring now to the drawings, FIGS. 1-6 disclose an example of an embodiment of the present invention, which is a post puller.

Generally, the invention is a post or stake puller comprising a jack assembly 13 with a detachable foot assembly 15. The jack assembly 13 typically has a hand crank 12 that comes with the jack assembly. However, such an assembly is also easily adaptable to not use the hand crank 12 and instead use a drill (not shown) with a bit that engages the hand crank hex nut.

Attached to the housing of the jack assembly 13 is a structural support base member 16 transversely fixed to an intermediate portion of the outer housing of the jack assembly 13. The structural support base member 16 can be an angle iron form welded or bolted to the jack assembly housing. Preferably, it is a flat steel material form 16A that is welded to or bolted to the jack housing or angle iron forms or gussets 16B can be welded to the flat form 16A and in turn fixed to the jack housing such as by welding.

The structural member 16 or flat form 16A has a vertically oriented face with a predetermined width and height, a pair of spaced-apart channel members 18, which have at least two contiguous sides generally perpendicular to each other. One edge of each of the pair of spaced-apart channel members 18 is fixed to the vertically oriented face on member 16, 16A and spaced-apart so as to act as a guide for placing the post puller adjacent a post 30 to be pulled where each channel member 18 is aligned juxtaposed opposite faces of the post 30 to be pulled. The face of member 16,16A can be about 3 inches in height and ¼ inch thick with a width sufficient to include the below described rods 17 and channel members 18 which straddle the post 30 to be removed. The gussets or angle irons 16B may be made from a one inch by one inch angle iron form or a one inch wide plate.

The invention includes a pair of rods 17 where each rod 17 has one end fixed to the vertically oriented face on member 16, 16A and oriented parallel to a corresponding spaced-apart channel member 18 leaving a gap between the corresponding spaced-apart channel member 18 and the rod 17. Each rod 17 has a predetermined length that is longer than the corresponding spaced-apart channel member 18. A pair of wedge members 19B have a predetermined length wherein at least one edge 19C of the wedge members 19B along the length of the wedge members 19B has a tapered edge 19C for biting into opposite faces of the post 30 to be pulled. Channel members 18 also serve to align the jack 13 to the post or stake 30 sides and to stop the wedges 19B from rotating too far.

The invention further includes a tubular-shaped member 19A that is fixed to each of the pair of wedge members 19B. The tubular-shaped member 19A has an internal dimension (typically about that of a one inch pipe) sufficient to concentrically slide over a corresponding rod 17 wherein a portion of the combined wedge member 19B and the tubular-shaped member 19A slides between the corresponding rod 17 and the corresponding spaced-apart channel member 18 and each of the combined wedge member 19B and tubular-shaped member 19A is rotatable about the corresponding rod 17 so that the tapered edge 19C is rotated against the post 30 to be pulled for biting as the outer housing of the jack assembly 13 is raised. Each of the combined wedge member 19B and tubular-shaped member 19A has a predetermined length that is shorter than the corresponding rod 17.

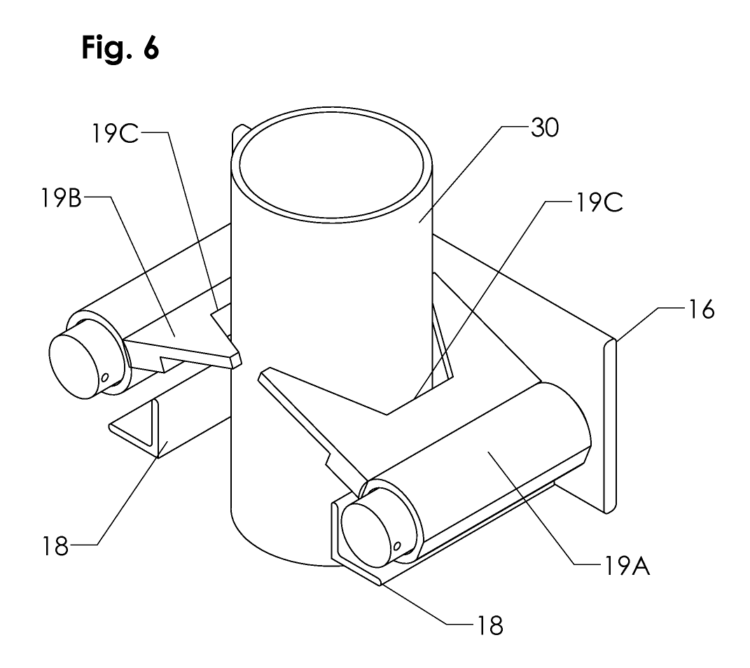

Wedge member 19B may be designed to have a tapered edge 19C that is linear, curved or any geometric form suitable for the application for which the invention is to be used. The tapered edge may be for example, V-shaped as in FIG. 6, circular shaped (not shown), or any shape formed to grasp the head of a metal or wooden stake such as that used to anchor tents. The intent is to have a wedge design that grips and bites into the post or stake to ensure no slippage of the invention along on the post or stake being removed.

The invention further comprises means for preventing said combined wedge member and tubular-shaped member 19A from sliding out of its engagement with the corresponding rod 17. This can be provided in a number of ways such as a removable cap (not shown) but a preferred method is by providing a washer 20 such as a one inch washer that slides over the rod 17 and a face of the washer 20 butts against an outer edge of the combined wedge member 19B and tubular-shaped member 19A, and a pin 21B such as a hair pin style Clevis pin is insertable through an aperture 21A adjacent an outer edge of the corresponding rod 17.

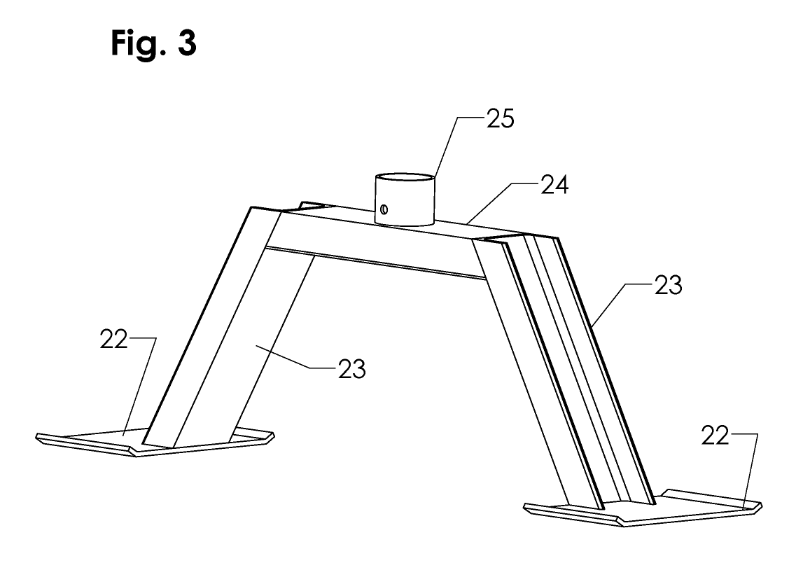

The detachable foot assembly 15 comprises a generally planar base member and a receptacle 14 for engaging a lower end of an inside shaft of the jack assembly 13. When the invention needs to straddle a post such those where concrete has been previously poured around a base of a post, an alternative foot assembly, an example of which is depicted in FIG. 3, may comprise two spaced-apart legs 23, where each the legs 23 has a generally planar base member 22 at corresponding lower ends of the legs 23. An upper transverse member 24 has a receptacle 25 on its upper surface for engaging the lower end of an inside shaft of the jack assembly 13. This embodiment may have the legs spread out over a 20 inch wide assembly.

The invention is clearly very easy for an operator to utilize. For posts or stakes, the device is placed next to, and up against, the post or stake to be removed. The operator applies a small amount of pressure squeezing the two wedges so they contact the surface of the post or stake and at the same time cranks the handle of the jack. As the jack moves up the sharpened side of the sharpened or tapered wedges rotate and dig or bite into the surface of the post or stake. The operator can also utilize a cordless or corded drill on the hex nut of the jack assembly. As the drill rotates the jack moves up, the post is removed from the ground. The travel of the jack is 10-12″ and will remove most posts buried 24″ with one cycle. For northern climates, where the posts are buried 48″ (to be below the frost line). It may require the jack to be repositioned to lift a second or third time.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. An apparatus for pulling posts and stakes from the ground comprising:
a jack assembly having an upper end and a lower end, the upper end having means for raising and lowering an outer housing of said jack assembly, the lower end having a detachable foot assembly;
a structural support base member transversely fixed to an intermediate portion of said outer housing of said jack assembly, said structural support base member having a vertically oriented face with a predetermined width and height;
a pair of spaced-apart channel members having at least two contiguous sides generally perpendicular to each other, one edge of each of said pair of spaced-apart channel members being fixed to said vertically oriented face and spaced-apart so as to act as a guide for placing said post puller adjacent a post to be pulled where each channel member is aligned juxtaposed opposite faces of said post to be pulled;
a pair of rods, each rod having one end fixed to said vertically oriented face and oriented parallel to a corresponding spaced-apart channel member leaving a gap between said corresponding spaced-apart channel member and said rod, each rod having a predetermined length that is longer than said corresponding spaced-apart channel member;
a pair of wedge members having a predetermined length wherein at least one edge of said wedge members along said length of said wedge members has a tapered edge for biting into said opposite faces of said post to be pulled, and a tubular-shaped member fixed to each of said pair of wedge members, said tubular-shaped member having an internal dimension sufficient to concentrically slide over a corresponding rod wherein a portion of said combined wedge member and said tubular-shaped member slides between said corresponding rod and said corresponding spaced-apart channel member and wherein each of said combined wedge member and tubular-shaped member is rotatable about said corresponding rod so that said tapered edge is rotated against said post to be pulled for biting as said outer housing of said jack assembly is raised, and each of said combined wedge member and tubular-shaped member having a predetermined length that is shorter than said corresponding rod.

2. The apparatus according to claim 1, further comprising:
means for preventing said combined wedge member and tubular-shaped member from sliding out of its engagement with said corresponding rod.

3. The apparatus according to claim 2, wherein said means for preventing said combined wedge member and tubular-shaped member from sliding out of its engagement with said corresponding rod comprises:
a washer that slides over said rod and a face of said washer butts against an outer edge of said combined wedge member and tubular-shaped member; and
a pin insertable through an aperture adjacent an outer edge of said corresponding rod.

4. The apparatus according to claim 1, wherein said detachable foot assembly comprises a generally planar base member and a receptacle for engaging a lower end of an inside shaft of the jack assembly.

5. The apparatus according to claim 1, wherein said detachable foot assembly comprises:
two spaced-apart legs, each of said legs having a generally planar base member at corresponding lower ends of said legs; and
a receptacle at an upper end of said detachable foot assembly for engaging a lower end of an inside shaft of said jack assembly.
